(19) United States
(12) Patent Application Publication
(10) Pub. No.: US 2026/0320516 A1
(43) Pub. Date: Oct. 15, 2026

(54) APPLICATION PROGRAM AND DEMAND RESPONSE MANAGEMENT SYSTEM

(71) Applicant: HONDA MOTOR CO., LTD., Tokyo (JP)

(72) Inventors: Yako Takahashi, Tokyo (JP); Tsubasa Watakabe, Tokyo (JP); Daisuke Inoue, Tokyo (JP); Shinya Yasuhara, Tokyo (JP); Thomas Stephen Pontefract, Tokyo (JP); Yohei Katori, Tokyo (JP)

(21) Appl. No.: 19/464,693

(22) Filed: Jan. 30, 2026

(30) Foreign Application Priority Data
Mar. 19, 2025 (JP) 2025-045793

(51) Int. Cl. G06Q 10/0631; G06N 20/00

(52) U.S. Cl. CPC G06Q 10/06311; G06N 20/00

(57) ABSTRACT

An application program causes a computer to: acquire a first schedule indicating a planned movement of a vehicle, the first schedule being input by a user who desires to participate in demand response in which power is exchanged between a battery of the vehicle and an external power source, and acquire a second schedule indicating candidate time periods for demand response that are estimated based on influence factors which influence control of demand response; display a schedule management screen including the first schedule and the second schedule on a display device; and receive, on the displayed schedule management screen, an instruction from the user to change the first schedule from a time when the schedule management screen is displayed to a first deadline which is set in advance.

### CROSS-REFERENCE TO RELATED APPLICATION

Priority is claimed on Japanese Patent Application No. 2025-045793, filed March 19, 2025, the content of which is incorporated herein by reference.

### BACKGROUND OF THE INVENTION

### Field of the Invention

The present invention relates to an application program and a demand response management system.

### Description of Related Art

In recent years, research has been conducted on a demand response (hereinafter, referred to as "DR") mechanism that balances supply and demand of electricity by controlling charging and discharging of a battery installed in a vehicle using a vehicle-to-grid (V2G) technology, which supplies electricity from a battery installed in a vehicle to a power system. For example, there has been proposed a method of adjusting a timing of participation in DR by providing users who desire to participate in DR with information such as a scheduled time for charging and discharging of a battery installed in a vehicle and a scheduled time for DR to request charging and discharging of the battery (refer to, for example, Patent Document 1 below).

### Patent Document 1

Japanese Unexamined Patent Application, First Publication No. 2023-180048

### SUMMARY OF THE INVENTION

However, in the technology in the related art, the user needs to calculate and input a scheduled time for charging and discharging the battery installed in the vehicle based on his/her own action plan, which may make participation in DR troublesome. In a case where the schedule needs to be changed after the scheduled battery charging/discharging time has been registered, a burden on the user to change the registered content increases.

Aspects of the present invention have been made in consideration of these circumstances, and one object of the aspects is to provide an application program and a demand response management system that can improve user convenience related to participation in demand response.

In order to solve the problem described above, the present invention employs the following aspects.
(1) According to an aspect of the present invention, there is provided an application program causing a computer to: acquire a first schedule indicating a planned movement of a vehicle, the first schedule being input by a user who desires to participate in demand response in which power is exchanged between a battery of the vehicle and an external power source, and acquire a second schedule indicating candidate time periods for demand response that are estimated based on influence factors which influence control of demand response; display a schedule management screen including the first schedule and the second schedule on a display device; and receive, on the displayed schedule management screen, an instruction from the user to change the first schedule from a time when the schedule management screen is displayed to a first deadline which is set in advance.
(2) In the aspect (1), the application program may further cause the computer to: acquire, after the first deadline, a third schedule indicating an assignment schedule of time periods for participation in demand response that are assigned to the user based on a demand response request from an external power source; and display the schedule management screen including the third schedule on the display device.
(3) In the aspect (2), on the schedule management screen, the first schedule and the second schedule may be displayed in parallel at the same time period in chronological order, and the first schedule and the third schedule may not be displayed in parallel at the same time period in chronological order.
(4) In the aspect (2), the application program may further cause the computer to: receive, on the displayed schedule management screen, an instruction from the user to cancel participation in demand response from a time when the schedule management screen including the third schedule is displayed to a second deadline which is set in advance.
(5) In the aspect (4), the application program may further cause the computer to: receive, on the displayed schedule management screen, an instruction for re-participation in demand response from the user who has issued the instruction to cancel participation in demand response.
(6) In the aspect (4), the application program may further cause the computer to: display, on the schedule management screen, information for prompting the user to re-participate in demand response, depending on the number of users who have issued an instruction to cancel participation in demand response.
(7) In the aspect (2), a period of the third schedule may be shorter than a period of the second schedule.
(8) In any one of the aspects (1) to (7), the influence factors may include at least one of weather forecast information or a past congestion status history of a system.
(9) In any one of the aspects (1) to (7), the second schedule may be estimated using a machine learning model obtained by performing training of a relationship between the influence factors and the candidate time periods for demand response.
(10) In any one of the aspects (1) to (7), on the schedule management screen, the first schedule, the second schedule, and the third schedule may be displayed in a distinguishable manner.
(11) According to another aspect of the present invention, there is provided a demand response management system including: an application program; and an estimation device, in which the application program causes a computer to: acquire a first schedule indicating a planned movement of a vehicle, the first schedule being input by a user who desires to participate in demand response in which power is exchanged between a battery of the vehicle and an external power source, and acquire a second schedule indicating candidate time periods for demand response that are estimated based on influence factors which influence control of demand response; display a schedule management screen including the first schedule and the second schedule on a display device; and receive, on the displayed schedule management screen, an instruction from the user to change the first schedule from a time when the schedule management screen is displayed to a first deadline which is set in advance, and the estimation device includes: an acquisition unit that acquires the influence factors under a condition in which demand response is performed; an estimation unit that estimates the candidate time periods for demand response corresponding to the acquired influence factor by using a machine learning model obtained by performing training of a relationship between the influence factors and the candidate time periods for demand response; and a transmission unit that transmits the estimated candidate time periods for demand response to the application program.

According to the aspects (1) to (11), it is possible to improve user convenience related to participation in demand response. Thereby, it is possible to prompt the user to participate in demand response.

### BRIEF DESCRIPTION OF THE DRAWINGS

FIG. 1 is a diagram illustrating an example of a configuration of a demand response management system according to an embodiment.

FIG. 2 is a functional block diagram illustrating an example of a configuration of a terminal device according to the embodiment.

FIG. 3 is a diagram illustrating an example of a vehicle use schedule setting screen displayed on the terminal device according to the embodiment.

FIG. 4 is a diagram illustrating an example of a demand response schedule management screen displayed on the terminal device according to the embodiment.

FIG. 5 is a diagram illustrating another example of a demand response schedule management screen displayed on the terminal device according to the embodiment.

FIG. 6 is a flowchart illustrating an example of a flow of processing of estimating candidate time periods for demand response in the charging/discharging management apparatus according to the embodiment.

FIG. 7 is a diagram illustrating an input/output relationship of an estimation model used in the estimation processing according to the embodiment.

FIG. 8 is a sequence diagram illustrating an example of a flow of demand response management processing in the demand response management system according to the embodiment.

### DETAILED DESCRIPTION OF THE INVENTION

Hereinafter, an embodiment of an application program and a demand response management system according to the present invention will be described with reference to the drawings.

### Entire Configuration

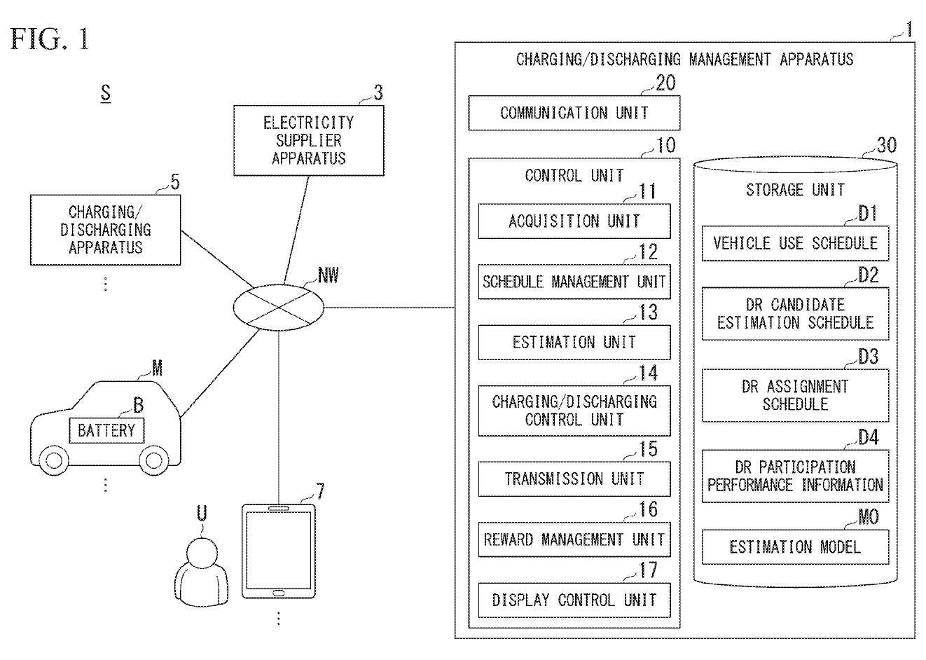

FIG. 1 is a diagram illustrating an example of a configuration of a demand response management system S (hereinafter, referred to as "DR management system S") according to an embodiment. The DR management system S performs demand response control (hereinafter, referred to as "DR control") by controlling charging and discharging of a battery by using V2G technology, which supplies electricity from a storage battery installed in a vehicle (hereinafter, referred to as "battery") to a power system (electricity trading market). The DR management system S provides a series of functions required for DR control, including management of DR participation plans for each user, management of execution of charging and discharging associated with DR control, and management of rewards for users who participate in DR.

The vehicle is incorporated into DR control, for example, in a case where a charging port of the vehicle is fitted into a charging plug of a charging/discharging apparatus installed in a user's residence. In a case where control to increase electricity demand (hereinafter, referred to as "increasing DR") in response to a request from an electricity supplier or the like is started, charging of the battery is performed. On the other hand, in a case where control to decrease electricity demand (hereinafter, referred to as "decreasing DR") in response to a request from an electricity supplier or the like is started, discharging of the battery (or an operation of holding charging of the battery) is performed.

The DR management system S includes, for example, a charging/discharging management apparatus 1, an electricity supplier apparatus 3, one or more charging/discharging apparatuses 5, one or more terminal devices 7, and one or more vehicles M. The apparatuses, the terminals, the vehicles, and the like included in the DR management system S are connected to each other via a communication network NW such that communication can be performed. The communication network NW is, for example, the Internet, a mobile communication network, a wide area network (WAN), a local area network (LAN), or a cellular network.

The charging/discharging management apparatus 1 performs overall control of the DR management system S. For example, the charging/discharging management apparatus 1 performs control of charging/discharging of a battery B installed in a vehicle M connected to the charging/discharging apparatus 5 in response to a demand response request (hereinafter, referred to as "DR plan") received from the electricity supplier apparatus 3. The charging/discharging management apparatus 1 will be described in detail later.

The electricity supplier apparatus 3 is used by an electricity supplier that supplies electricity, such as an electricity transmission/distribution operator or a retail electricity supplier. The electricity supplier apparatus 3 generates a DR plan (for example, a daily DR plan) according to an energy storage status, and notifies electricity consumers such as companies and households of the DR plan. In the DR management system S, the electricity supplier apparatus 3 transmits the DR plan to the charging/discharging management apparatus 1 via the communication network NW, for example, on a daily basis.

The charging/discharging apparatus 5 (also referred to as "charging/discharging facility") performs charging and discharging of the battery B installed in the vehicle M. The charging/discharging apparatus 5 is installed, for example, at a residence of a user U of the vehicle M or at a public charging station. The charging/discharging apparatus 5 performs charging of the battery B using system energy supplied from a general power distribution network (system, commercial power supply) or renewable energy generated by a power generation apparatus installed in a residence or the like. The charging/discharging apparatus 5 performs discharging of the battery B by returning the electricity stored in the battery B to the system.

The vehicle M is, for example, a four-wheeled vehicle, a two-wheeled vehicle, a three-wheeled vehicle, or the like. A drive source of the vehicle is, for example, an electric motor or a combination of an electric motor and an internal combustion engine such as a diesel engine or a gasoline engine. The electric motor operates using discharged electricity from the battery B, which is a secondary battery or a fuel cell, or power generated by a generator connected to the internal combustion engine. The vehicle M is, for example, an electric vehicle, a hybrid vehicle, an electric motorcycle, or the like.

The vehicle M is used, for example, by a user U (also called "driver"). In a case where the user U returns to his/her residence, the user U connects (links) a charging plug of the charging/discharging apparatus 5 installed in his/her residence with the charging port of the vehicle M. Thus, charging/discharging of the vehicle M is enabled. Alternatively, the user U goes to a charging station, and connects (links) a charging plug of the charging/discharging apparatus 5 installed at the charging station with the charging port of the vehicle M. Thus, charging/discharging of the vehicle M is enabled.

The terminal device 7 is used, for example, by the user U. The terminal device 7 is, for example, a smartphone, a tablet terminal, a general-purpose personal computer, or the like. The terminal device 7 may be coupled to the vehicle M and may function as an in-vehicle device. The terminal device 7 transmits information input by the user U to the charging/discharging management apparatus 1 and the like. The terminal device 7 outputs information transmitted from the charging/discharging management apparatus 1, and notifies the user U of the information. The terminal device 7 realizes various functions to participate in DR control by executing a demand response application (hereinafter, referred to as "DR application") that is installed in advance. These various functions may be realized using a general-purpose application program such as a web browser that operates on the terminal device 7. The terminal device 7 will be described in detail later.

### Charging/Discharging Management Apparatus

Next, details of a configuration of the charging/discharging management apparatus 1 will be described. As illustrated in FIG. 1, the charging/discharging management apparatus 1 includes, for example, a control unit 10, a communication unit 20, and a storage unit 30.

The control unit 10 controls the overall operation of the charging/discharging management apparatus 1. The control unit 10 includes, for example, an acquisition unit 11, a schedule management unit 12, an estimation unit 13, a charging/discharging control unit 14, a transmission unit 15, a reward management unit 16, and a display control unit 17. Each functional unit of the control unit 10 is realized in a case where a hardware processor (computer) such as a central processing unit (CPU) executes a program (software). Some or all of these components may be realized by hardware such as large scale integration (LSI), an application specific integrated circuit (ASIC), a field-programmable gate array (FPGA), a graphics processing unit (GPU), and a system on chip (SOC), or may be realized by software and hardware in cooperation. The charging/discharging management apparatus 1 is not limited to a single apparatus, and each functional unit of the control unit 10 may be realized by a plurality of apparatuses that work together.

The acquisition unit 11 acquires various information from external devices via the communication network NW. The acquisition unit 11 acquires various information stored in the storage unit 30. For example, the acquisition unit 11 acquires various input information related to DR control that is input by the user U of the vehicle M via the terminal device 7. The acquisition unit 11 acquires, from an external device (not illustrated), an influence factor that influences DR control (hereinafter, referred to as "DR influencing factor") under a condition in which DR control is performed. The DR influence factor includes, for example, weather prediction data (also referred to as "weather forecast information"), including information on weather and temperature (average temperature, highest temperature, lowest temperature, and the like) for each day and time period, as well as information on date, day of the week, season, and the like. The acquisition unit 11 acquires, from an external device (not illustrated), information related to a past congestion history (congestion situation history) of the electricity system, information related to a past implementation history of DR control, and the like.

The schedule management unit 12 manages various schedules related to DR control. For example, the schedule management unit 12 associates a vehicle use schedule which is input by the user U via the terminal device 7 with the user U (or vehicle M), and registers the vehicle use schedule in a vehicle use schedule D1 stored in the storage unit 30. The schedule management unit 12 registers a schedule of a candidate time period for DR (hereinafter, referred to as "DR candidate time period") estimated by the estimation unit 13 in a DR candidate estimation schedule D2 stored in the storage unit 30. Based on a DR plan transmitted from the electricity supplier apparatus 3 and a vehicle use schedule of each user, the schedule management unit 12 selects a user (vehicle) that requests participation in DR control (also referred to as "DR assignment"), creates a schedule for DR participation for each user (vehicle), and registers the schedule in a DR assignment schedule D3 stored in the storage unit 30.

The estimation unit 13 estimates DR candidate time periods during which request for DR control is estimated based on DR influence factors. For example, the estimation unit 13 estimates DR candidate time periods by using an estimation model MO. The estimation model MO is, for example, a machine learning model (deep neural network, DNN) obtained by performing training of a relationship between DR influence factors and DR time periods. In addition, the estimation model MO may be generated using any machine learning technique, such as a technique based on logistic regression analysis or support vector machine. The estimation unit 13 (the charging/discharging control unit 14 including the estimation unit 13) is an example of an "estimation device".

The charging/discharging control unit 14 adjusts exchange of power between the battery B and an external power source (for example, a power system and a power trading market) by controlling charging/discharging of the battery B of each vehicle M on the basis of the DR assignment schedule D3. The charging/discharging control unit 14 controls charging/discharging of the battery B of each vehicle M by transmitting a charging/discharging control request based on a DR request to the charging/discharging apparatus 5 associated with the user U registered as a participation target in the DR assignment schedule D3 (for example, the charging/discharging apparatus 5 installed at the residence of the user U).

The transmission unit 15 transmits information of various schedules (the vehicle use schedule D1, the DR candidate estimation schedule D2, and the DR assignment schedule D3) stored in the storage unit 30 to the terminal device 7 (DR application AP) in response to a request from the terminal device 7.

The reward management unit 16 manages rewards for the users U according to performance of participation in the exchange of power between the battery B and the external power source. The reward management unit 16 associates the reward for the user U with the user U (or vehicle M), and registers the reward for the user U in a DR participation performance information D4 stored in the storage unit 30.

The display control unit 17 controls the display of the display unit (display device) of the terminal device 7. The display control unit 17 operates when the user U performs processing for participation in DR control by using a web browser or the like which operates on the terminal device 7, instead of (or in addition to) executing the DR application AP. The display control unit 17 generates notification information for the user (information indicating the contents of the display) on the basis of processing results of various functions of the control unit 10, and transmits the notification information to the terminal device 7. Thereby, various information is displayed on the display unit of the terminal device 7.

The communication unit 20 performs communication with external devices such as the electricity supplier apparatus 3, the charging/discharging apparatus 5, the terminal device 7, and the vehicle M via the communication network NW. The communication unit 20 is, for example, a network card for connection to the communication network NW.

The storage unit 30 stores various information required for DR control. The storage unit 30 is realized by, for example, an HDD, a flash memory, an electrically erasable programmable read only memory (EEPROM), a read only memory (ROM), or a random access memory (RAM). The storage unit 30 stores, for example, the vehicle use schedule D1, the DR candidate estimation schedule D2, the DR assignment schedule D3, the DR participation performance information D4, the estimation model MO, and the like. The storage unit 30 may be realized by another storage device connected via the communication network NW, such as an external storage server device.

### Terminal Device

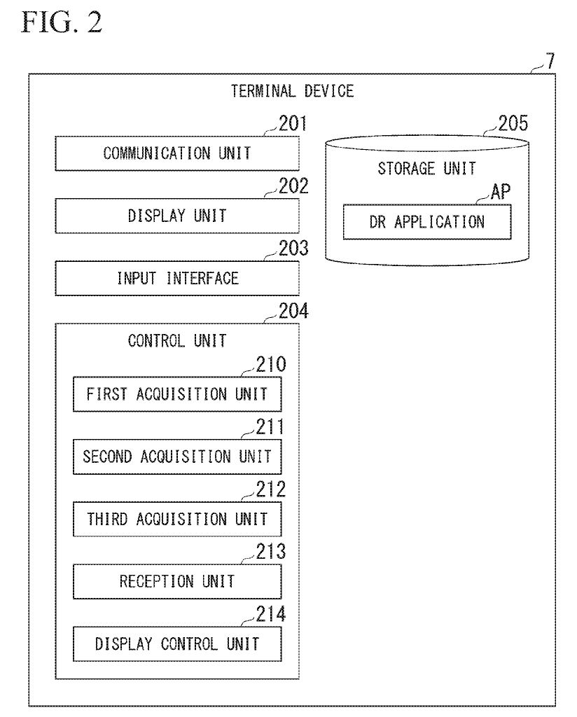

FIG. 2 is a functional block diagram illustrating an example of a configuration of the terminal device 7 according to the embodiment. The terminal device 7 includes, for example, a communication unit 201, a display unit 202, an input interface 203, a control unit 204, and a storage unit 205.

The communication unit 201 performs communication with external devices such as the charging/discharging management apparatus 1, the electricity supplier apparatus 3, the charging/discharging apparatus 5, and the vehicle M via the communication network NW. The communication unit 201 is, for example, a network card for connection to the communication network NW.

The display unit 202 displays various information related to DR control. The display unit 202 displays images generated by the control unit 204 and a graphical user interface (GUI) to receive various input operations from the user U. For example, the display 202 is a liquid crystal display (LCD), an organic electroluminescence (EL) display, or the like.

The input interface 203 receives various input operations from the user U, converts the received input operations into electrical signals, and outputs the electrical signals to the control unit 204. For example, the input interface 203 includes a touch panel, a keyboard, a mouse, and the like.

The control unit 204 controls the overall operation of the terminal device 7. For example, the control unit 204 realizes various functions for participation in DR control in a case where a hardware processor (computer) such as a CPU executes the DR application AP stored in the storage unit 205. The control unit 204 realizes, for example, a schedule management function, a reward management function, and the like. The control unit 204 includes, for example, a first acquisition unit 210, a second acquisition unit 211, a third acquisition unit 212, a reception unit 213, and a display control unit 214.

The first acquisition unit 210 acquires a first schedule (vehicle use schedule) indicating a planned movement of the vehicle, the first schedule being input by the user U who desires to participate in DR for exchanging of power between the battery B of the vehicle M and the external power source. The first acquisition unit 210 acquires the vehicle use schedule registered in association with the user U from the charging/discharging management apparatus 1. The first acquisition unit 210 acquires the vehicle use schedule input by the user U via the input interface 203.

The second acquisition unit 211 acquires a second schedule (DR candidate estimation schedule) indicating the candidate time periods for demand response that are estimated on the basis of the DR influence factors.

The third acquisition unit 212 acquires a third schedule (DR assignment schedule) indicating an assignment schedule of participation time periods in DR, the assignment schedule being assigned to the users on the basis of the DR plan.

The reception unit 213 receives various instructions input by the user U via the input interface 203. The reception unit 213, for example, receives an instruction from the user U to change the vehicle use schedule on the schedule management screen displayed on the display unit 202, from the display of the schedule management screen to a first deadline. The first deadline is set at a predetermined timing based on an execution date and/or a start timing of DR control. The first deadline is, for example, a predetermined timing (for example, 10 PM) on the day before execution of DR control. At the timing, a DR assignment schedule for the next day (from midnight to midnight) is generated. Alternatively, the first deadline is, for example, 24 hours (1 day) before execution of DR control. Even after the first deadline, the user U can change the vehicle use schedule itself, but the change is not considered in generation of the DR assignment schedule. The reception unit 213, for example, receives an instruction from the user U to cancel participation in DR, on the schedule management screen displayed on the display unit 202, from the display of the schedule management screen including the DR assignment schedule to a second deadline. The second deadline is set at a predetermined timing based on an execution date and/or a start timing of DR control. The second deadline is, for example, one hour before execution of DR control.

The display control unit 214 controls the display of the display unit 202 of the terminal device 7. The display control unit 214 displays various information related to DR control on the display unit 202. The display control unit 214 displays a schedule management screen, a GUI for receiving various input operations from the user U, and the like on the display unit 202.

The storage unit 205 stores various information related to DR control. The storage unit 205 is realized by, for example, an HDD, a flash memory, an EEPROM, a ROM, or a RAM. The storage unit 205 stores, for example, a DR application AP and the like. The DR application is an example of an "application program.

### Vehicle Use Schedule Setting Screen

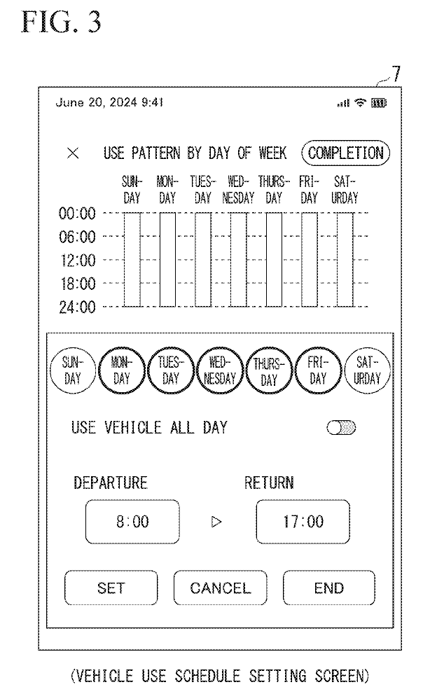

FIG. 3 is a diagram illustrating an example of a vehicle use schedule setting screen displayed on the terminal device 7 according to the embodiment. In this vehicle use schedule setting screen, the user can specify one or more days of the week as a setting target and then set a vehicle use time (a departure time and a return time). In the example illustrated in FIG. 3, Monday through Friday (weekdays) is specified as the setting target, and "departure 08:00" and "return 17:00" are set as the vehicle use time.

### DR Schedule Management Screen

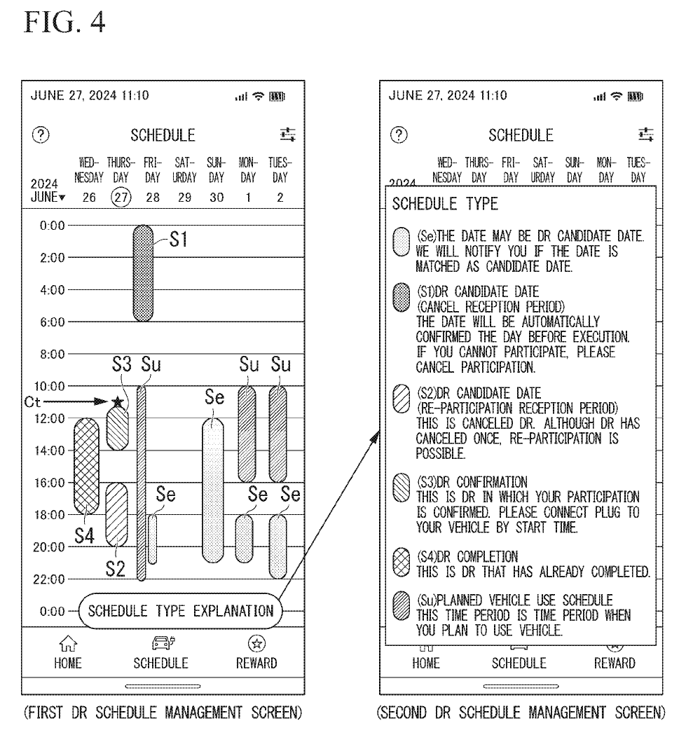

FIG. 4 is a diagram illustrating an example of a DR schedule management screen displayed on the terminal device 7 according to the embodiment. In the DR schedule management screen, various schedules are displayed in a visually distinguishable manner according to an execution status of DR control. The various schedules include, for example, a planned vehicle use schedule Su, a DR candidate estimation schedule Se, a DR candidate date (cancel reception period) schedule S1, a DR candidate date (re-participation reception period) schedule S2, a DR confirmation schedule S3, and a DR completion schedule S4.

The planned vehicle use schedule Su indicates a vehicle use schedule registered by the user U on a vehicle use schedule setting screen. The DR candidate estimation schedule Se indicates a schedule of DR candidate time periods estimated by the estimation unit 13 of the charging/discharging management apparatus 1. For example, the DR candidate estimation schedule Se is automatically confirmed, and is changed to the DR candidate date (cancel reception period) schedule S1, for example, on the day before execution (24 hours before). The DR candidate estimation schedule Se is changed on the basis of the DR assignment schedule generated on the basis of the actual DR plan, and then is changed to the DR candidate date (cancel reception period) schedule S1. The period of the DR candidate date (cancel reception period) schedule S1 (the DR assignment schedule, the third schedule) is shorter than the period of the DR candidate estimation schedule Se (the second schedule). Depending on the content of the DR plan actually received from the electricity supplier apparatus 3, the period of the DR candidate date (cancel reception period) schedule S1 (the DR assignment schedule, the third schedule) may be longer than the period of the DR candidate estimation schedule Se (the second schedule).

The DR candidate date (cancel reception period) schedule S1 is a DR candidate schedule assigned to the user on the basis of the DR candidate estimation schedule and the vehicle use schedule, and indicates a schedule for which cancel of participation in DR can be received. For example, the DR candidate date (cancel reception period) schedule S1 is confirmed before execution of DR control (for example, one hour before), and is changed to the DR confirmation schedule S3.

The DR candidate date (re-participation reception period) schedule S2 is a schedule for which cancel is received once in the DR candidate date (cancel reception period) schedule S1, and indicates a schedule for a period (for example, one hour before) before execution of DR control. Here, in a case where re-participation is received, the DR candidate date (re-participation reception period) schedule S2 is again changed to the DR candidate date (cancel reception period) schedule S1.

The DR confirmation schedule S3 indicates, for example, a schedule for DR in which participation has been confirmed and a predetermined time limit has passed until execution of DR control (a time limit of one hour until execution of DR control). The DR completion schedule S4 indicates a past DR schedule that has already completed.

FIG. 4 illustrates an example of a first DR schedule management screen displayed at the current timing Ct (11:10 on June 27, 2024). In this example, "June 28, 10:00 to 22:00", "July 1, 10:00 to 16:00", and "July 2, 10:00 to 16:00" are displayed as the planned vehicle use schedule Su. As the DR candidate estimation schedule Se, "June 28, 18:00 to 21:00", "June 30, 12:00 to 21:00", "July 1, 18:00 to 21:00", and "July 2, 18:00 to 22:00" are displayed. Here, as in the schedule for June 28, the planned vehicle use schedule Su (the first schedule) and the DR candidate estimation schedule Se (the second schedule) can be displayed in parallel at the same time in chronological order.

The DR schedule that has already completed is displayed for a period corresponding to the past of the current timing Ct, and the DR schedule that is not yet executed is displayed for a period corresponding to the future of the current timing Ct. For example, "June 26, 12:00 to 18:00" is displayed in a column for June 26, which is the past of the current timing Ct, as the DR completion schedule S4. At a timing immediately after the current timing Ct, "June 27, 11:30 to 14:00" is displayed as the DR confirmation schedule S3. Here, the DR confirmation schedule S3 is set so as not to overlap with the planned vehicle use schedule Su. In other words, the planned vehicle use schedule Su (the first schedule) and the DR confirmation schedule S3 (the third schedule) are controlled so as not to be displayed in parallel in the same time period in chronological order.

As the DR candidate date (re-participation reception period) schedule S2, "June 27, 16:00 to 20:00" is displayed. As the DR candidate date (cancel reception period) schedule S1, "June 28, 0:00 to 6:00" is displayed.

In a case where a "schedule type explanation" button on the first DR schedule management screen is pressed, a second DR schedule management screen is displayed. In the second DR schedule management screen, the user can confirm the explanation of various schedule types.

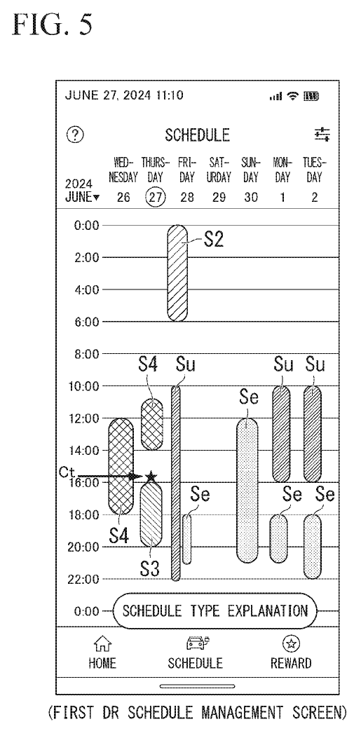

FIG. 5 illustrates an example of the first DR schedule management screen displayed at the current timing Ct (15:50, June 27, 2024) when 4 hours and 40 minutes has passed after the current timing (11:10, June 27, 2024) illustrated in FIG. 4. In this example, the schedule displayed in FIG. 4 as the DR confirmation schedule S3 "June 27, 11:30 to 14:00" is changed to the DR completion schedule S4, which has already completed, and is displayed.

In a case where, on the schedule displayed in FIG. 4 as the DR candidate date (re-participation reception period) schedule S2 "June 27, 16:00 to 20:00", the user U requests re-participation, the DR candidate date schedule S2 is subsequently changed to the DR confirmation schedule S3 in FIG. 5, and is displayed. In a case where, on the schedule displayed in FIG. 4 as the DR candidate date (cancel reception period) schedule S1 "June 28, 0:00 to 6:00", the user U requests cancel, the DR candidate date schedule S1 is subsequently changed to the DR candidate date (re-participation reception period) schedule S2 illustrated in FIG. 5, and is displayed.

In this embodiment, for example, the same forecast information (the DR candidate estimation schedule) is uniformly transmitted to all users (user groups divided by regions or the like). For this reason, in a case where there are a large number of participants in DR control, as a result of the assignment, a participant may be excluded from targets for DR control, and the DR control schedule that has displayed as the DR candidate estimation schedule Se may disappear. Alternatively, in a case where accuracy of the DR candidate estimation schedule is poor and the prediction is incorrect, the DR control schedule may disappear or may be significantly changed. For example, as a result of the change, the DR candidate date schedule S2 may be set outside the prediction range (the DR candidate estimation schedule Se). Even in these cases, the planned vehicle use schedule Su and the DR candidate date schedule S2 or the DR confirmation schedule S3 are controlled so as not to be displayed in parallel in the same time period in chronological order.

### Processing Flow

### Estimation Processing for DR Candidate Time Period

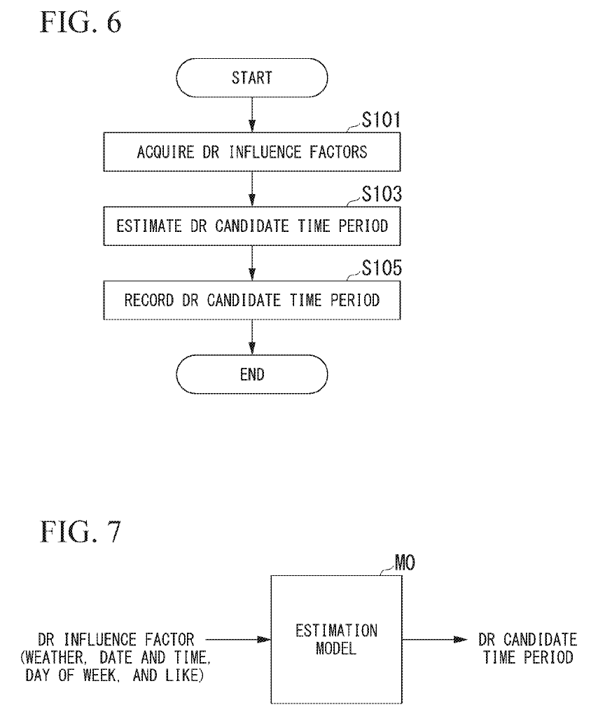

Next, processing in the DR management system S will be described. FIG. 6 is a flowchart illustrating an example of a flow of estimation processing of the charging/discharging management apparatus 1 according to the embodiment. The processing illustrated in FIG. 6 is started by automatically executing the estimation processing at a predetermined timing, for example, date and time, weekly, or the like. Alternatively, the processing is started when an administrator of the charging/discharging management apparatus 1 inputs an instruction to execute the estimation processing via an input interface (not illustrated).

First, the acquisition unit 11 acquires the DR influence factors from an external device (not illustrated) via the communication network NW (step S101). The DR influence factors include, for example, weather forecast data including information of a weather and a temperature (for example, an average temperature, a maximum temperature, and a minimum temperature) for each day and each time period. The acquisition unit 11 may also acquire other information such as date, day of the week, and the like that are set in a computer of the charging/discharging management apparatus 1.

Next, the estimation unit 13 estimates a DR candidate time period by using the acquired DR influence factors (step S103). For example, the estimation unit 13 estimates a DR candidate time period by using the estimation model MO that is stored in advance in the storage unit 30. FIG. 7 is a diagram illustrating a relationship between input and output of the estimation model MO used in the estimation processing according to the embodiment. The estimation model MO is trained to output a DR candidate time period in a case where the DR influence factors are input. The estimation model MO is generated, for example, by training, as training data, a set of the DR influence factors (for example, weather conditions) and past DR control execution history information associated with the DR influence factors.

Next, the estimation unit 13 records the estimated DE candidate time period in the storage unit 30 (step S105). Thereby, the processing of the flowchart is ended.

### DR Scheduling Management Processing

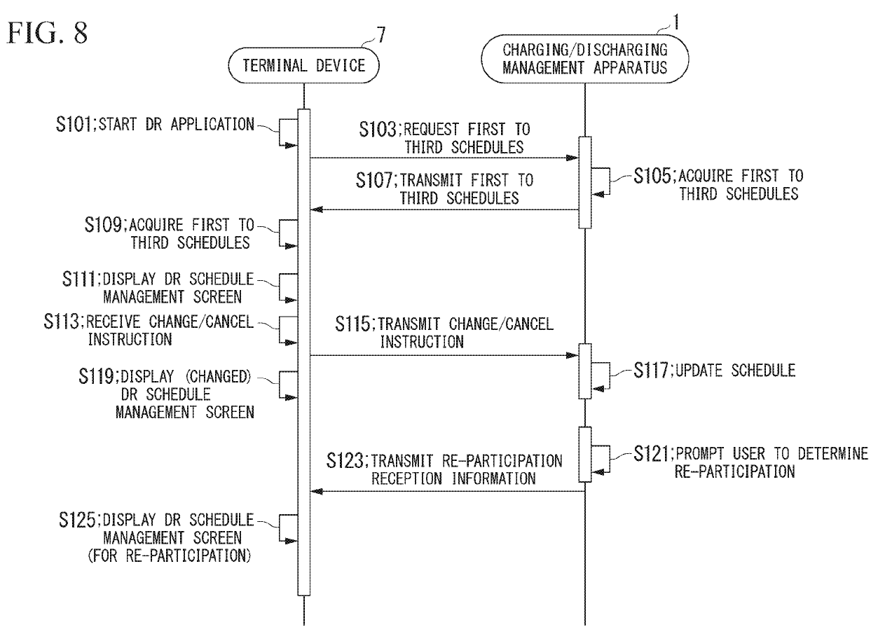

FIG. 8 is a sequence diagram illustrating an example of a flow of the demand

response management processing in the demand response management system S according to the embodiment. The following description will be given assuming that the vehicle use schedule D1, the DR candidate estimation schedule D2, and the DR assignment schedule D3 have already been registered in the storage unit 30 of the charging/discharging management apparatus 1.

First, the DR application AP is started in response to an operation of the terminal device 7 by the user U (step S101). Next, the terminal device 7 transmits, to the charging/discharging management apparatus 1, a request for the vehicle use schedule (the first schedule), the DR candidate estimation schedule (the second schedule), and the DR assignment schedule (the third schedule) that are associated with the user U (an identifier such as a user ID) (step S103). In response to this request, the acquisition unit 11 of the charging/discharging management apparatus 1 acquires, from the storage unit 30, the vehicle use schedule (the first schedule), the DR candidate estimation schedule (the second schedule), and the DR assignment schedule (the third schedule) that are associated with the user U (step S105). Next, the transmission unit 15 of the charging/discharging management apparatus 1 transmits, to the terminal device 7, the acquired vehicle use schedule (the first schedule), the DR candidate estimation schedule (the second schedule), and the DR assignment schedule (the third schedule) (step S107).

Next, the first acquisition unit 210, the second acquisition unit 211, and the third acquisition unit 212 of the terminal device 7 respectively acquire the vehicle use schedule (the first schedule), the DR candidate estimation schedule (the second schedule), and the DR assignment schedule (the third schedule) (step S109).

Next, the display control unit 214 of the terminal device 7 displays, on the display unit 202, a DR schedule management screen on the basis of the vehicle use schedule (the first schedule), the DR candidate estimation schedule (the second schedule), and the DR assignment schedule (the third schedule) (step S111). The display control unit 214 displays, for example, the DR schedule management screen illustrated in FIG. 4 on the display unit 202. By confirming the DR schedule management screen displayed on the display unit 202, the user U can recognize his/her own participation schedule in DR control and the like.

Here, in a case where the user U inputs an instruction to change the vehicle use schedule or to cancel the DR confirmation schedule for which the user is scheduled to participate by operating the input interface 203, the reception unit 213 of the terminal device 7 receives the change/cancel instruction (step S113), and transmits the instruction to the charging/discharging management apparatus 1 (step S115). In a case where the change/cancel instruction is received, the schedule management unit 12 of the charging/discharging management apparatus 1 updates the schedule and registers the updated schedule in the storage unit 30 (step S117). The display control unit 214 of the terminal device 7 displays the changed DR schedule management screen on the display unit 202 (step S119).

The schedule management unit 12 of the charging/discharging management apparatus 1 determines whether or not DR control is influenced by an increase in the number of users who cancel participation in DR control for satisfying the DR plan (step S121). In a case where there are too many users who cancel participation in DR control (for example, in a case where the number of users who cancel participation in DR control is equal to or larger than a threshold value which depends on the number of users who cancel participation), the schedule management unit 12 transmits, for example, to the terminal device 7 of a user U other than the users who cancel participation in DR control (a user U who was not selected as a candidate), re-participation reception information for prompting re-participation (step S123). Thereby, the display control unit 214 of the terminal device 7 of a user U other than the users who cancel participation in DR control displays, on the display unit 202, the DR schedule management screen including information for prompting re-participation (for example, the DR candidate date (re-participation reception period) schedule S2) (step S125). By displaying the DR schedule management screen, it is possible to secure participants in DR control. Thereby, the processing of the sequence diagram is ended.

In the above description, the DR application AP is executed on the terminal device 7, and the display control of the terminal device 7 is mainly performed on the DR application AP side. However, the present invention is not limited to this configuration, and the display control may be performed on the charging/discharging management apparatus 1 side. In this case, the user U may confirm the DR schedule management screen controlled on the charging/discharging management apparatus 1 side by using a general-purpose application program such as a web browser that operates on the terminal device 7. In this case, the program that operates on the charging/discharging management apparatus 1 is an example of an "application program.

According to the DR management system S in the embodiment described above, user convenience for participation in DR can be improved. By providing a display function of the schedule management screen for displaying the estimated candidate time periods for which DR is to be requested, it is possible to set a participation reception period in the schedule after the candidate time periods are displayed. Thus, it is possible to secure more participants for DR. The user can change his/her participation/non-participation in the schedule for DR which is assigned to the user and in which participation has been confirmed. The display on the schedule management screen is also changed according to the change, and thus, the user can accurately and easily confirm the schedule.

While a mode for carrying out the present invention has been described above with reference to an embodiment, the present invention is not limited to the embodiment, and various modifications and substitutions can be performed thereon without departing from the gist of the present invention.

What is claimed is:

1. An application program causing a computer to:
acquire a first schedule indicating a planned movement of a vehicle, the first schedule being input by a user who desires to participate in demand response in which power is exchanged between a battery of the vehicle and an external power source, and acquire a second schedule indicating candidate time periods for demand response that are estimated based on influence factors which influence control of demand response;
display a schedule management screen including the first schedule and the second schedule on a display device; and
receive, on the displayed schedule management screen, an instruction from the user to change the first schedule from a time when the schedule management screen is displayed to a first deadline which is set in advance.

2. The application program according to claim 1, further causing the computer to:
acquire, after the first deadline, a third schedule indicating an assignment schedule of time periods for participation in demand response that are assigned to the user based on a demand response request from an external power source; and
display the schedule management screen including the third schedule on the display device.

3. The application program according to claim 2, wherein
on the schedule management screen, the first schedule and the second schedule are displayed in parallel at the same time period in chronological order, and
the first schedule and the third schedule are not displayed in parallel at the same time period in chronological order.

4. The application program according to claim 2, further causing the computer to:
receive, on the displayed schedule management screen, an instruction from the user to cancel participation in demand response from a time when the schedule management screen including the third schedule is displayed to a second deadline which is set in advance.

5. The application program according to claim 4, further causing the computer to:
receive, on the displayed schedule management screen, an instruction for re-participation in demand response from the user who has issued the instruction to cancel participation in demand response.

6. The application program according to claim 4, further causing the computer to:
display, on the schedule management screen, information for prompting the user to re-participate in demand response, depending on the number of users who have issued an instruction to cancel participation in demand response.

7. The application program according to claim 2, wherein
a period of the third schedule is shorter than a period of the second schedule.

8. The application program according to claim 1, wherein
the influence factors include at least one of weather forecast information or a past congestion status history of a system.

9. The application program according to claim 1, wherein
the second schedule is estimated using a machine learning model obtained by performing training of a relationship between the influence factors and the candidate time periods for demand response.

10. The application program according to claim 2, wherein
on the schedule management screen, the first schedule, the second schedule, and the third schedule are displayed in a distinguishable manner.

11. A demand response management system comprising:
an application program; and
an estimation device, wherein
the application program causes a computer to:
acquire a first schedule indicating a planned movement of a vehicle, the first schedule being input by a user who desires to participate in demand response in which power is exchanged between a battery of the vehicle and an external power source, and acquire a second schedule indicating candidate time periods for demand response that are estimated based on influence factors which influence control of demand response;
display a schedule management screen including the first schedule and the second schedule on a display device; and
receive, on the displayed schedule management screen, an instruction from the user to change the first schedule from a time when the schedule management screen is displayed to a first deadline which is set in advance, and
the estimation device includes:
an acquisition unit that acquires the influence factors under a condition in which demand response is performed;
an estimation unit that estimates the candidate time periods for demand response corresponding to the acquired influence factor by using a machine learning model obtained by performing training of a relationship between the influence factors and the candidate time periods for demand response; and
a transmission unit that transmits the estimated candidate time periods for demand response to the application program.
